(19) United States
(12) Patent Application Publication
(10) Pub. No.: US 2007/0211163 A1
(43) Pub. Date: Sep. 13, 2007

(54) Image Sensor Package and Method for Manufacturing the Same

(75) Inventor: Cheng-Wei Huang, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ADVANCED SEMICONDUCTOR ENGINEERING INC., Kaohsiung (TW)

(21) Appl. No.: 11/617,176

(22) Filed: Dec. 28, 2006

(30) Foreign Application Priority Data
Mar. 10, 2006 (TW) 95108200

(51) Int. Cl. H04N 5/225

(52) U.S. Cl. 348/340

(57) ABSTRACT

An image sensor package and a method for manufacturing the same are provided, wherein an image sensor chip facing downwards is assembled in a frame during the manufacture of the package so as to prevent the chip from being contaminated by falling dust and minute foreign objects.

### RELATED APPLICATIONS

The present application is based on, and claims priority from, Taiwan Application Serial Number 95108200, filed Mar. 10, 2006, the disclosure of which is hereby incorporated by reference herein in its entirety.

### FIELD OF THE INVENTION

The present invention relates to an image sensor, and more particularly, to the structure of an image sensor package. Further, the present invention related to a method for manufacturing the aforementioned image sensor package.

### BACKGROUND OF THE INVENTION

Referring to FIG. 1 showing the structure of a conventional image sensor package 100, the image sensor package 100 includes a substrate 110 having a top surface 112 and bottom surface 114, wherein the top surface 112 has a plurality of first contacts 116 formed thereon, and the bottom surface 114 has a plurality of second contacts 118 formed thereon; a flange layer 180 which is a frame structure disposed on the top surface 112, wherein the flange layer 180 forms an accommodation space 140 with the substrate 110; an image sensor chip 160 disposed on the top surface 112 inside the accommodation space 140; a plurality of conductive wires 120 used for electrically the image sensor chip 160 to the first contacts 116; and a transparent layer 190 covering the flange layer 180 so as to cover the image sensor chip 160.

During the operation process for constructing the aforementioned image sensor package 100, the sensor surface of the imager sensor chip generally faces upwards, and is susceptible to the pollution resulted from the falling dust and minute foreign objects.

In view of this, it is desirable to modify the method for manufacturing the conventional image sensor package so as to resolve the aforementioned problem.

### SUMMARY OF THE INVENTION

One aspect of the present invention is to provide a method for manufacturing an image sensor package, wherein the image sensor chip generally faces downwards, so as to prevent that the image sensor chip from being polluted by the falling dust and minute foreign objects.

According to one embodiment of the present invention, in a method for manufacturing an image sensor package, a transparent layer and a frame are first provided, wherein the frame has a carrier plate and a sidewall extending upwards from the edge of the carrier plate, and an accommodation space is defined by the sidewall and the carrier plate. A top surface of the carrier plate has an opening penetrating through a bottom surface of the carrier plate, and the bottom surface of the carrier plate is disposed on the transparent layer. Then, an image sensor chip is provided, wherein there is an image sensor area disposed on a front side of the image sensor chip, and there are a plurality of output terminals disposed on a back side of the image sensor chip. The front side of the image sensor chip faces downwards, and then the image sensor chip is disposed on the top surface of the carrier plate inside the accommodation space, and the image sensor area is exposed to the opening, and the output terminals are used to electrically connect the image sensor chip with an external electric circuit substrate.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 is a schematic cross-sectional view showing the structure of a conventional image sensor package; and

FIG. 2a to FIG. 2d are schematic cross-sectional views showing the process for manufacturing a sensor chip package according to an embodiment of the present invention, wherein FIG. 2d illustrates the end product completed.

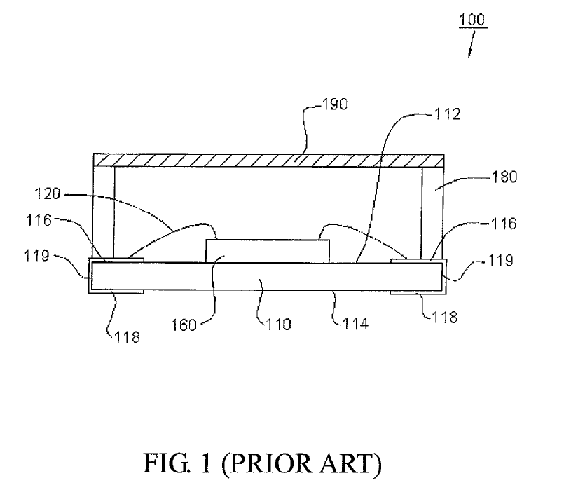

### DETAILED DESCRIPTION OF THE PREFERRED EMBODIMENT

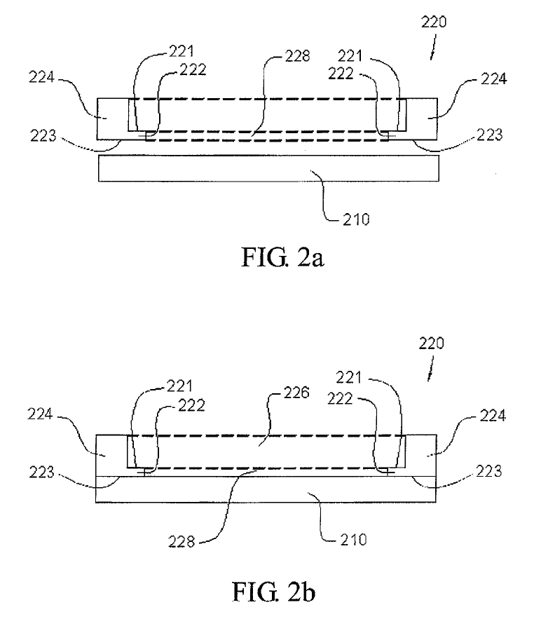

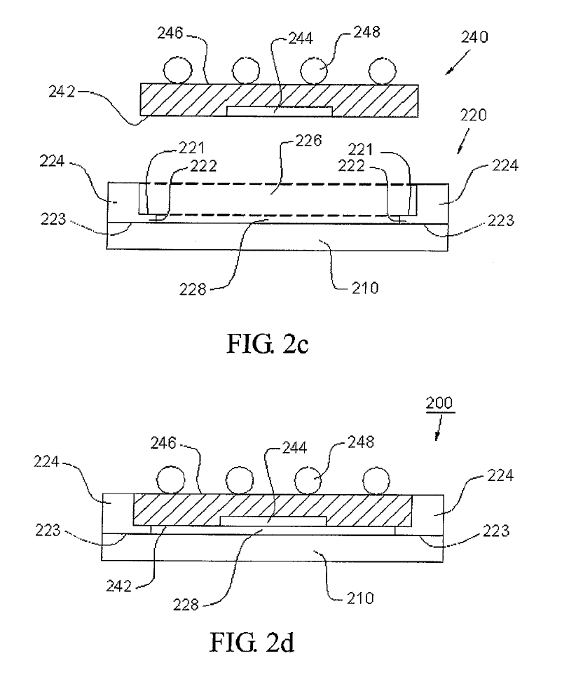

FIG. 2a to FIG. 2d are schematic cross-sectional views showing the process for manufacturing an image sensor chip package 200 (shown in FIG. 2d) according to an embodiment of the present invention, wherein the process comprises the steps of providing a transparent layer 210; providing a frame 220; and providing an image sensor chip 240. The frame 220 has a carrier plate 222 and a sidewall 224 extending upwards in a frame shape from the edge of the carrier plate 222, and there is an accommodation space 226 defined by the sidewall 224 and the carrier plate 222. A top surface 221 of the carrier plate 222 has an opening 228 penetrating through a bottom surface 223 of the carrier plate 222. The opening 228 and the sidewall 224 are properly spaced from each other, and the bottom surface 223 of the carrier plate 222 is disposed on the transparent layer 210. Then, the image sensor chip 240 has an image sensor area 244 disposed on a front side 242 thereof, and a plurality of output terminals 248 disposed on a back side 246 thereof. The image sensor chip 240 is disposed on the top surface of the carrier plate inside the accommodation space with the front side 242 thereof facing downwards, and the image sensor area 244 is exposed to the opening 228, wherein the output terminals 248 are used to electrically connect the image sensor chip 240 with an external electric circuit substrate (not shown).

According to the structure of the image sensor package 200, the light reflected from the image passes through the transparent layer 210 and reaches the image sensor area 244, and then an image electrical signal is transmitted to the external components via the output terminals 248. The transparent layer 210 of the image sensor package 200 can be an optical glass with an IR/AR (Infrared Resistant/Antireflection) electroplated film. The frame 220 is made of reinforced glass fiber resin or silicon, and is attached to the transparent layer 210 via adhesive bonding or anode bonding, etc. Further, the image sensor chip 240 can be attached to the frame 220 via an adhesive.

With respect to the aforementioned structure of the image sensor package according to the present invention, in its manufacturing process, the image sensor chip is assembled in the frame in the manner of facing its image sensor area downwards, so that the image sensor chip can be prevented from being polluted by the falling dust and minute foreign objects.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure.

What is claimed is:

1. An image sensor package, comprising:
a transparent layer;
a frame having a carrier plate and a sidewall extending upwards from the edge of the carrier plate, wherein an accommodation space is defined by the sidewall and the carrier plate, and a top surface of the carrier plate has an opening penetrating through a bottom surface of the carrier plate, and the opening and the sidewall are properly spaced from each other, and the bottom surface of the carrier plate is disposed on the transparent layer; and
an image sensor chip having an image sensor area disposed on a front side of the image sensor chip, and a plurality of output terminals disposed on a back side of the image sensor chip, wherein the front side of the image sensor chip faces downwards, and then the image sensor chip is disposed on the top surface of the carrier plate inside the accommodation space, and the image sensor chip is exposed to the opening, and the output terminals are used to electrically connect the image sensor chip with an external electric circuit substrate.

2. The image sensor package of claim 1, wherein the transparent layer is an optical glass.

3. The image sensor package of claim 2, wherein the optical glass has an IR/AR (Infrared Resistant/Antireflection) electroplated film.

4. The image sensor package of claim 1, wherein the frame is made of reinforced glass fiber resin or silicon.

5. The image sensor package of claim 1, wherein the frame is attached to the transparent layer via adhesive bonding or anode bonding.

6. The image sensor package of claim 1, wherein the image sensor chip is attached to the frame via an adhesive.
